(19) United States
(12) Patent Application Publication
(10) Pub. No.: US 2007/0292068 A1
(43) Pub. Date: Dec. 20, 2007

(54) FREE-WHEEL DRIVE MECHANISM

(76) Inventor: Jody Mayne, Grand Saline, TX (US)

Correspondence Address: WOOD AND EISENBERG, PLLC, 6911 RICHMOND HIGHWAY, SUITE 403, Alexandria, VA, 22306, US

(21) Appl. No.: 11/421,442

(22) Filed: May 31, 2006

(51) Int. Cl. F16C 13/00

(52) U.S. Cl. 384/544

(57) ABSTRACT

A free-wheel drive mechanism, which when fitted to an axle driven vehicle wheel selectively allows the vehicle wheel to free-wheel during vehicle deceleration. The free-wheel drive mechanism includes: a sleeve of generally cylindrical appearance and having a hollow bore adapted for fixedly receiving a drive axle; a one-way bearing, which houses the sleeve; and a drive flange, which houses the one-way bearing. The one-way bearing can by any suitable one-way bearing such as a sprag bearing. In one embodiment, the front end of the sleeve defines a plurality of recesses and the front end of the drive flange comprises a complementary plurality of recesses between which an optional interlocking member is used to interlock the sleeve and the drive flange to prevent the free-wheel effect. When the sleeve and the drive flange are not interlocked the sleeve can free-wheel inside the one-way bearing during vehicle deceleration.

### CROSS-REFERENCE TO RELATED APPLICATIONS

Not applicable

### STATEMENT REGARDING FEDERALLY SPONSORED RESEARCH OR DEVELOPMENT

Not Applicable.

### FIELD OF THE INVENTION

This invention relates to a free-wheel drive mechanism designed to allow an axle driven wheel to free-wheel while the vehicle is in deceleration mode.

### BACKGROUND OF THE INVENTION

High performance racing vehicles such as stock cars used in stock car racing typically have very large engines. Such engines typically enjoy high-compression ratios and generate large amounts of torque. The torque generated by the stock car engine is typically directed to the rear wheels of the stock car. To reduce vehicle speed, a stock car driver typically takes his/her foot off the gas (accelerator) pedal whereupon the stock car engine quickly slows down the rear wheels.

On the straight part of a dirt stock car circuit such rapid deceleration can present a problem particularly while cornering and decelerating hard. More particularly, the outside rear wheel will tend to turn faster than the inside rear wheel rendering the stock car less stable during tight cornering. While conventional limited slip differentials perform adequately in ordinary engined vehicles, such differential mechanisms offer but limited relief in powerful rear wheel drive vehicles such as, but not limited to, stock racing cars, particularly for stock cars run on dirt tracks.

U.S. Pat. No. 6,520,885, issued Feb. 18, 2003 to Gassmann et al., describes an axle disconnect device for use in an all wheel drive vehicle. The Gassmann '885 axle disconnect device includes a one-way overrunning clutch and a spring contacting the clutch. A spline locking ring contacts the spring on an end opposite of the clutch. A friction dog spline engages the surface of the spline locking ring while a differential ramp ring contacts the friction dog spline. The axle disconnect device also includes a cover ramp engaging the differential ramp ring. More particularly, the Gassmann '885 axle disconnect device is intended to provide an overrunning clutch mechanism that works in unison with a disconnect device, such that when the reverse gear is chosen the reverse differential will be able to transmit torque.

U.S. Pat. No. 6,932,734, issued Aug. 23, 2005 to Hwa et al., describes a planetary gear apparatus that includes a pair of internal ring gears interconnected to be driven together, a pair of planetary gear assemblies each associated with a respective internal ring gear, and each comprising plural pairs of planet gears, where each pair of planet gears has an outer planet gear in mesh with the respective internal ring gear and with its inner planet gear; and a pair of sun gears each associated with a respective planetary gear assembly. The planetary gear apparatus of the invention can be incorporated into the transfer case or differential housing of a four-wheel-drive vehicle so that the dual internal ring gears and central pinion shafts become the main distributors of driving torque, delivering equal full-time traction and possessing the capacity of differentiating rotational speed between the front and rear drive shafts and between the opposite wheels of the vehicle in straight driving or during cornering. More importantly, even when one wheel or one axle of the driven four-wheel-drive vehicle has lost traction, or suspended above the ground, all the driving torque will the distributed to the axles and related wheels that are still in contact.

U.S. Pat. No. 5,908,225, issued Jun. 1, 1999 to Meier, describes a process for ensuring a neutral vehicle handling during cornering and a simultaneous load change is provided by the operation of a vehicle system having at least one driven axle, an axle differential gear, wheel brakes for the selective deceleration of an individual wheel, a device for recognizing a cornering and a device for recognizing a coasting operation and for generating a signal corresponding to the intensity of the coasting operation. The problem of rear-wheel driven and front-wheel driven vehicles is the vehicle handling during cornering in the coasting operation. As a result, depending on the method of operation, an over steering or under steering of the vehicle is caused. The process avoids these problems in that, during a cornering, a wheel of the driven axle is decelerated at least as a function of the coasting operation signal such that the moment generated thereby, such as a counter-yawing moment, compensates the yawing moment caused by the cornering during the coasting operation.

U.S. Pat. No. 5,226,861, issued Jul. 13, 1993 to Engle, describes a limited slip differential for an axle system of a vehicle is disclosed which includes internal clutches for connecting a slipping wheel to the drive input of the differential. The differential is also responsive to inertia forces on the vehicle during hard cornering to prevent slippage of the inside wheel during cornering.

### SUMMARY OF THE INVENTION

A free-wheel drive mechanism, which when fitted to an axle driven vehicle wheel selectively allows the vehicle wheel to free-wheel during vehicle deceleration. The free-wheel drive mechanism includes: a sleeve of generally cylindrical appearance and having a hollow bore adapted for fixedly receiving a drive axle; a one-way bearing, which houses the sleeve; and a drive flange, which houses the one-way bearing. The one-way bearing can by any suitable one-way bearing such as a sprag bearing. The free-wheel drive mechanism can include more than one one-way bearing. In one embodiment, the front end of the sleeve defines a plurality of recesses and the front end of the drive flange comprises a complementary plurality of recesses between which an optional interlocking member is used to interlock the sleeve and the drive flange to prevent the free-wheel effect. When the sleeve and the drive flange are not interlocked the sleeve can free-wheel inside the one-way bearing during vehicle deceleration.

### BRIEF DESCRIPTION OF THE DRAWINGS

FIG. 1A is an environmental perspective view of a free-wheel drive mechanism attached to a wheel, according to the present invention.

FIG. 1B shows a side view of the free-wheel drive mechanism attached to a wheel.

FIG. 2 shows a close up of the free-wheel drive mechanism shown in FIG. 1.

FIG. 3A shows an exploded view of the first embodiment of the invention.

FIG. 3B shows an exploded view of the second embodiment of the invention.

FIG. 3C shows an exploded view of the second embodiment of the invention further comprising a snap-ring.

FIG. 4A shows an end view of the free-wheel mechanism, according to the invention.

FIG. 4B shows a perspective view of the free-wheel mechanism shown in FIG. 4A.

Similar reference characters denote corresponding features consistently throughout the attached drawings.

### DETAILED DESCRIPTION OF THE INVENTION

This invention is directed to a free-wheel drive mechanism designed to allow an axle driven wheel to selectively free-wheel while the vehicle is in deceleration mode. The free-wheel drive mechanism of the invention is denoted by the numeric label

The free-wheel drive mechanism 100 is typically fitted to an axle driven vehicle wheel such as an outside rear wheel on a rear wheel driven vehicle. It is anticipated that the free-wheel drive mechanism 100 would be fitted to a stock car as used in stock car racing, a form of automobile racing typically, but not always, held on oval tracks, such as banked concrete oval tracks, of between approximately 0.5 miles and about 2.7 miles in length and occasionally on conventional racing circuits, also known as road courses. Ovals shorter than one mile (1.6 km) are called short tracks; unpaved short tracks are called dirt tracks; longer ovals are typically known as superspeedways. Races are generally 200 to 600 miles (300-1000 km) in length. Average speeds in the top classes are around 160 miles per hour. Some NASCAR races can get up to speeds of 200 miles per hour at tracks such as the Daytona International Speedway and the Talladega Superspeedway.

The term “outside rear wheel” is the rear wheel that is on the rear outside of a rear wheel drive vehicle as the vehicle approaches or negotiates a corner. Thus, with respect to a left turn, the outside rear wheel would be the right rear wheel, and with respect to a right turn, the outside rear wheel would be the left rear wheel. Thus, for rear wheel drive racing cars running counter-clockwise on an oval track (from the driver's perspective the counter-clockwise circuit would appear to comprise left hand curves), a mechanic would typically attach the free-wheel drive mechanism 100 to the right rear wheel such that the free-wheel drive mechanism 100 forms part of the right rear wheel-hub. With respect to rear wheel drive racing cars running clockwise on an oval track, thus comprising right hand curves, a mechanic would typically attach the free-wheel drive mechanism 100 to the left rear wheel such that the free-wheel drive mechanism 100 forms part of the left rear wheel-hub.

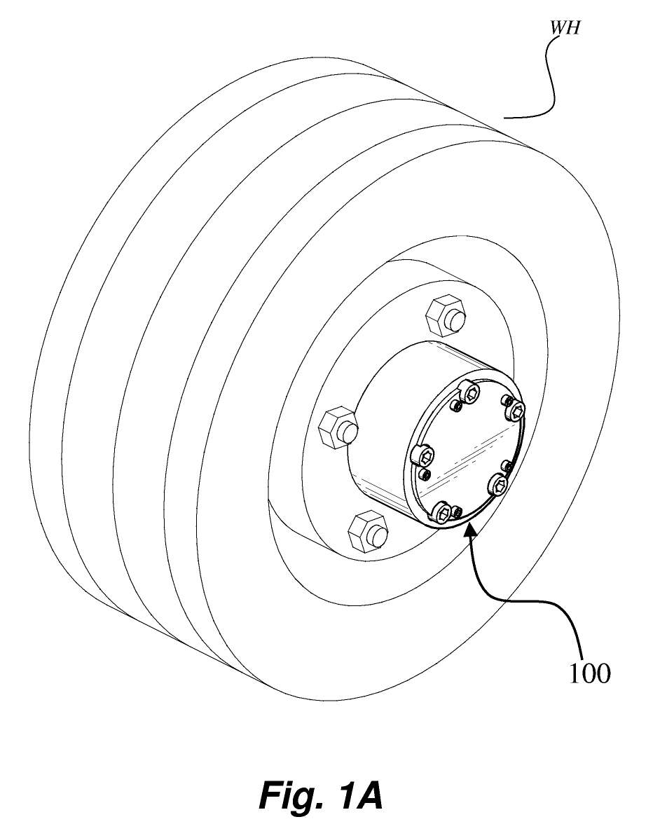

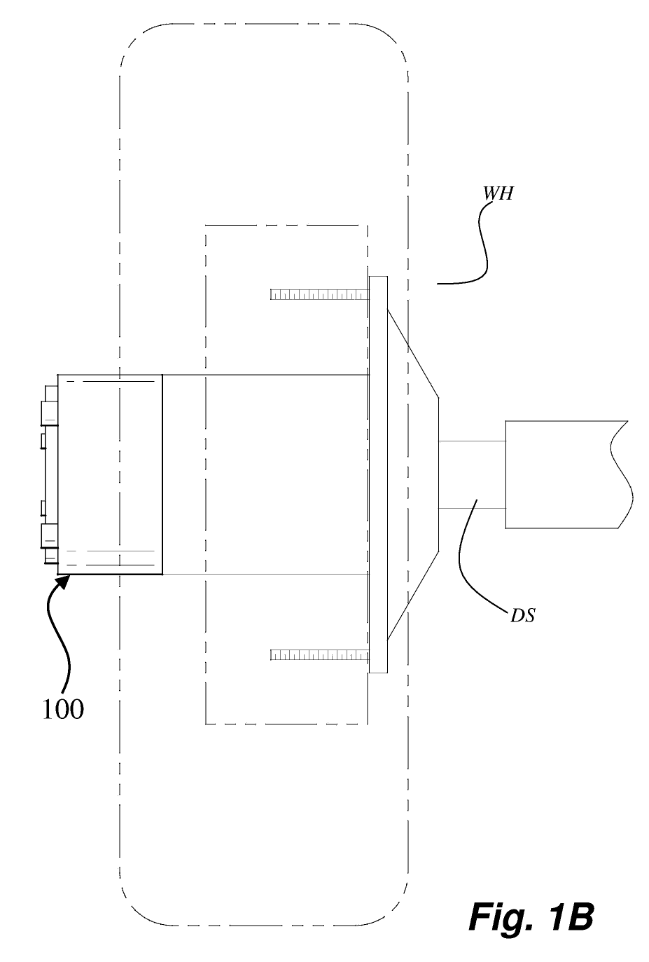

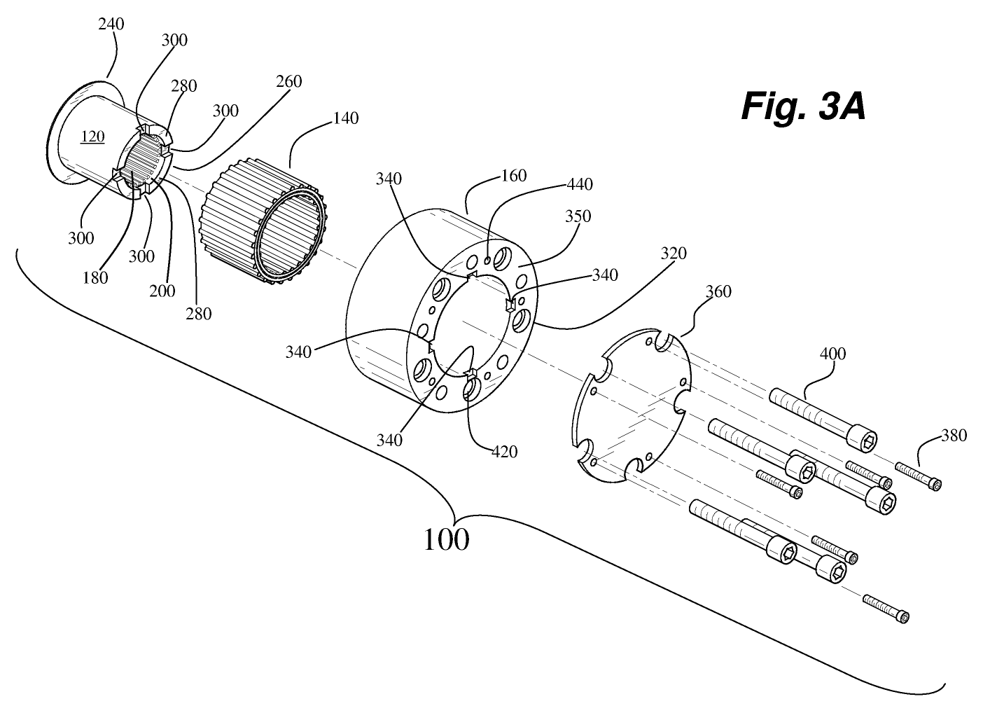

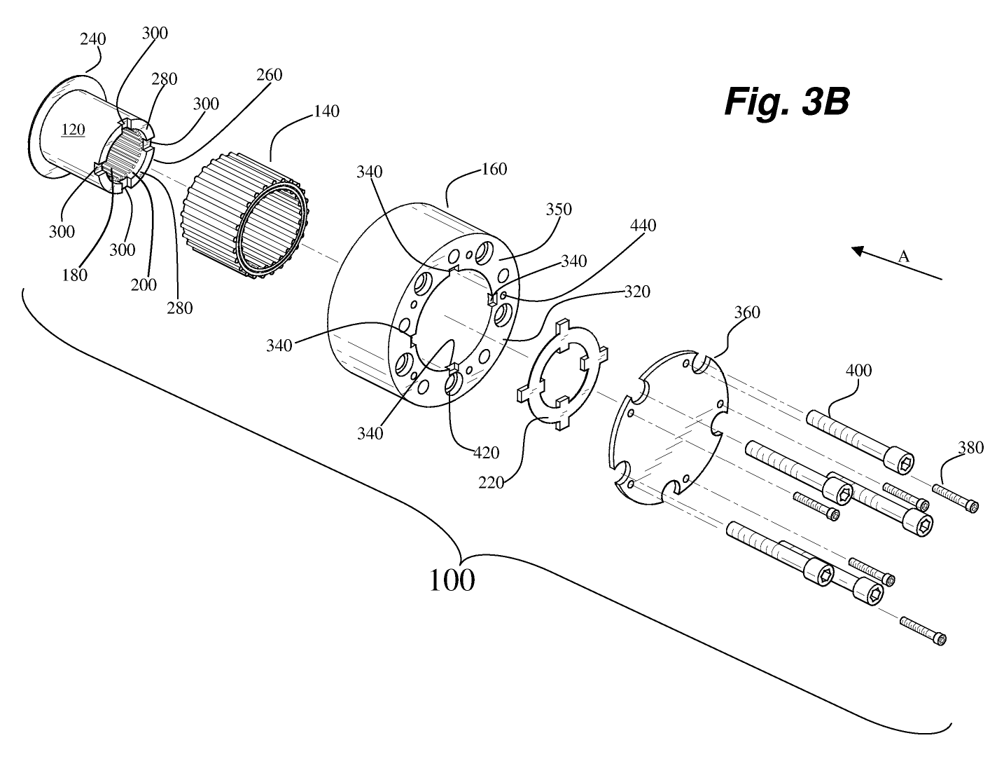

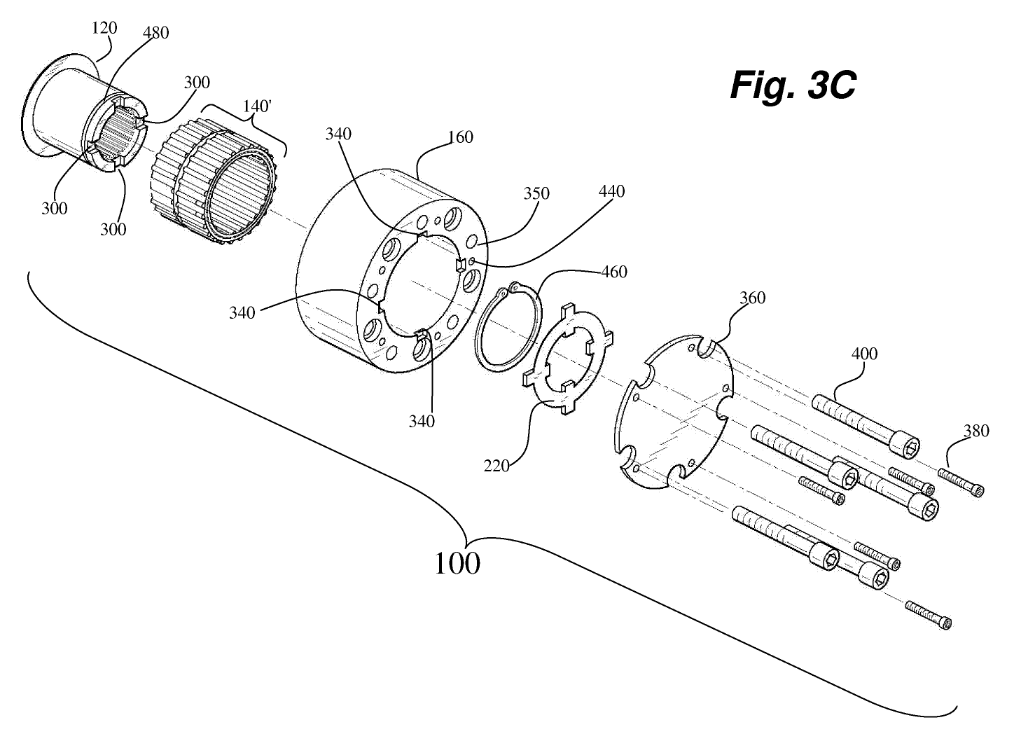

In a first embodiment, a non-limiting version of which is shown in FIG. 3A, the free-wheel drive mechanism 100 comprises: a sleeve 120, a one-way bearing 140, and a drive flange 160. The sleeve 120 is adapted to couple to a drive shaft DS (shown in FIG. 1B) for rotation by the latter. For example, longitudinal splines 180 can be formed on the inner cylindrical face 200 of sleeve 120 and cooperate with corresponding longitudinal splines formed at the wheel-hub end of shaft DS. The sleeve 120 is located inside the one-way bearing 140, and the one-way bearing 140 is located inside the drive flange 160. The one-way bearing 140 can be any suitable one-way bearing mechanism such as, but not limited to, a sprag bearing. The tolerances should be such that the sleeve 120 transmits torque from the vehicles drive shaft DS to the drive flange 160 via the one-way bearing 140, while allowing the sleeve 120 to free-wheel during deceleration, i.e., rotate faster than the drive shaft DS during deceleration, thereby allowing a wheel operably attached to the free-wheel drive mechanism 100 to also free-wheel during deceleration. It should be understood that the one-way bearing 140 can include more than a single one-way bearing as shown, for example, in FIG. 3C.

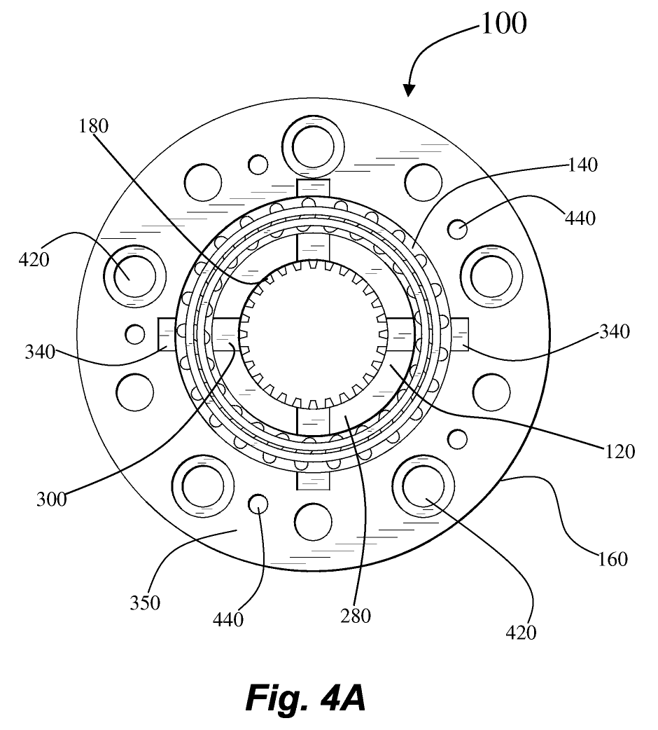

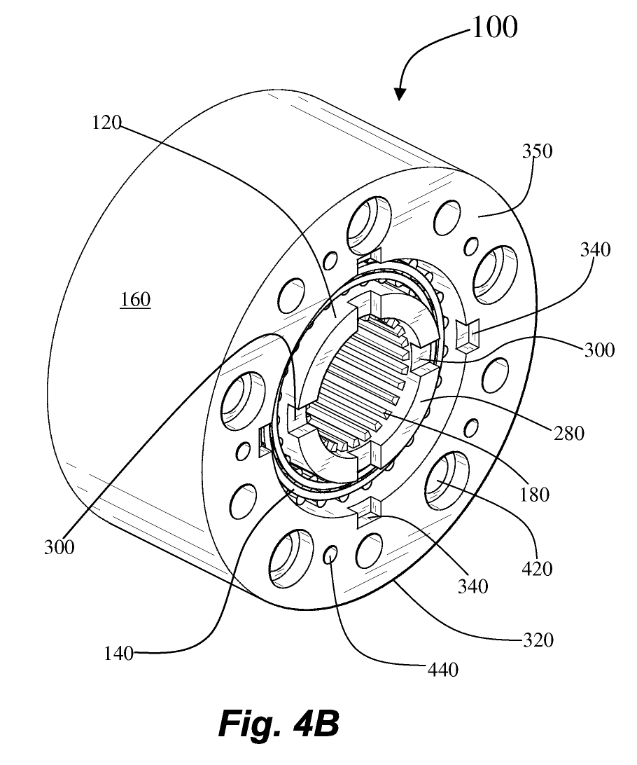

In a second embodiment, a non-limiting version of which is shown in FIG. 3B, the free-wheel drive mechanism 100 further comprises an interlocking member 220. In this embodiment, the sleeve 120 has an axle-receiving end 240 and a front end 260. The front end 260 defines a radial face 280. A plurality of recesses 300 are located in the radial face 280 of sleeve 120. The drive flange 160 has a front end 320. The front end 320 of the drive flange 160 defines radial face 350 and therein a plurality of recesses 340. The recesses 300 and 340 respectively on the sleeve 120 and the drive flange 160 are shaped to cooperatively accommodate the interlocking member 220. The interlocking member 220 is used to interlock the sleeve 120 and the drive flange 160; a mechanic merely lines up recesses 300 and 340 (see, e.g., FIG. 4B), then secures the interlocking member 220 across the lined up recesses 300 and 340 and holds the interlocking member 220 in place by means of cover plate 360 (see FIG. 3B). It should be understood that any suitable means can be used to hold the interlocking member 220 in place to interlock sleeve 120 and drive flange 160.

When the sleeve 120 and the drive flange 160 are interlocked by the interlocking member 220 the free-wheel mechanism 100 behaves as a conventional drive mechanism wherein the sleeve 120 is prevented from freewheeling inside the one-way bearing 140 during deceleration and in turn preventing an attached wheel from free-wheeling during deceleration.

Referring to the FIGURES of which FIG. 1A shows an environmental perspective view of the free-wheel drive mechanism 100 fitted to a wheel WH, and FIG. 1B shows a side view thereof.

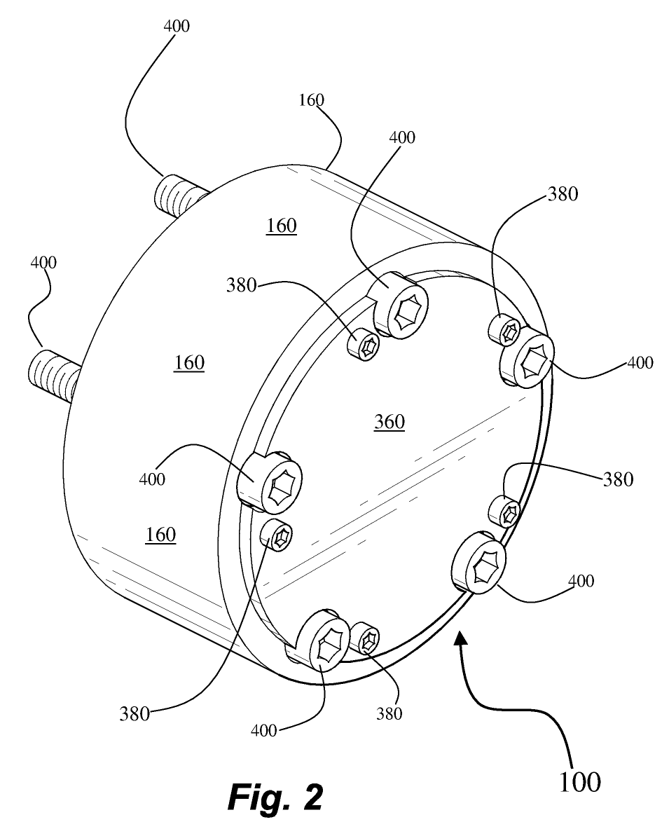

FIG. 2 shows a close up of the exterior of the free-wheel drive mechanism 100 shown in FIG. 1A. The exterior of the drive flange 160 is shown along with a cover plate 360 which is held in place against by means of fasteners 380. The fasteners 380 can take any suitable form such as threaded bolts, e.g., alum key bolts. The various labeled parts are described in more detail below.

FIG. 3A shows an exploded view of the first embodiment of the invention, in which the free-wheel drive mechanism 100 comprises: a sleeve 120, a one-way bearing 140, a drive flange 160, a cover plate 360, fasteners 380, and drive flange securing bolts 400. The drive flange securing bolts 400 secure the free-wheel drive mechanism 100 to the rest of the wheel WH (see FIG. 1B). Torque actually transmitted to the drive flange 160 is transmitted to the wheel WH via bolts 400. In this embodiment, the interlocking member 220 is absent. Thus, the sleeve 120 will free-wheel inside the one-way bearing 140 during deceleration mode, e.g., as the vehicle (not shown) approaches a corner. While recesses 300 and 340 are included in FIG. 3A, their actual presence in the first embodiment is optional.

In contrast, the embodiment shown in FIG. 3B includes the interlocking member 220, which causes the free-wheel mechanism 100 to operate as a conventional drive mechanism, wherein the sleeve 120 is prevented from freewheeling inside the one-way bearing 140 during deceleration and in turn prevents an attached wheel from free-wheeling during deceleration.

FIG. 3C shows a snap-ring 460 and a snap-ring groove 480 in sleeve 120. The snap-ring groove 480 is used to hold the snap-ring 460 in place. The one-way bearing 140 includes two one-way bearings (represented by the numeric label 140′, i.e., 140 prime). Thus, the one-way bearing 140 can be combined with at least one other one-way bearing, such as, but not limited to, two one-way sprag bearings. The snap-ring 460 is used to hold the one-way bearing 140 in place around sleeve 120.

FIG. 4A shows an end view in the direction A (see FIG. 3B) of the free-wheel mechanism 100 with the cover plate 360, bolts or fasteners 380 and 400, and interlocking member 220 absent. Apertures 420 in the drive flange 160 accommodate bolts 400, and apertures 440 accommodate fasteners 380. FIG. 4B shows a perspective view of the free-wheel mechanism 100 shown in FIG. 4A.

It should be understood that the free-wheel drive mechanism 100 can also be attached to wheel-hubs on four wheel drive vehicles. It should also be understood that the free-wheel drive mechanism 100 should only be fitted and used with the understanding that reversing a vehicle fitted with free-wheel drive mechanism 100 may present problems.

It is to be understood that the present invention is not limited to the embodiments described above or as shown in the attached figures, but encompasses any and all embodiments within the spirit of the invention.

I claim:

1. A free-wheel drive mechanism, which when fitted to an axle driven vehicle wheel selectively allows the vehicle wheel to free-wheel during vehicle deceleration, comprising:
a sleeve adapted to couple to a drive axle;
a one-way bearing, wherein said one-way bearing houses said sleeve; and
a drive flange, wherein said drive flange houses said one-way bearing.

2. The free-wheel drive mechanism according to claim 1, wherein said one-way bearing is a sprag bearing, wherein the sprag bearing is held in place around said sleeve by means of a snap-ring.

3. The free-wheel drive mechanism according to claim 1, wherein said one-way bearing further includes at least one other one-way bearing.

4. The free-wheel drive mechanism according to claim 1 further comprising:
an interlocking member,
wherein said sleeve has an axle-receiving end and a front end, said front end defining a radial face,
wherein a plurality of recesses are located in said radial face of said sleeve,
wherein said drive flange has a front end and said front end of said drive flange comprises a plurality of recesses,
wherein said recesses on said sleeve and said drive flange are shaped to cooperatively accommodate said interlocking member, and
wherein said interlocking member is used to interlock said sleeve and said drive flange,
whereby when said sleeve and said drive flange are interlocked by said interlocking member said free-wheel mechanism behaves as a conventional drive mechanism wherein said sleeve is prevented from freewheeling inside said one-way bearing during deceleration and in turn preventing an attached wheel from free-wheeling during deceleration.

5. The free-wheel drive mechanism according to claim 4 further comprising a cover plate for holding said interlocking member in place in said recesses of said sleeve and said drive flange.

6. A free-wheel drive mechanism configurable to selectively operate in vehicle deceleration mode, comprising:
a sleeve of generally cylindrical appearance and having a hollow bore for fixedly receiving the wheel end of a drive axle;
a sprag bearing, wherein said sleeve is located inside said sprag bearing;
a drive flange, wherein said drive flange houses said sprag bearing; and
an interlocking member, wherein said interlocking member is selectively used to interlock said sleeve and said drive flange,
whereby when said sleeve and said drive flange are interlocked by said interlocking member said free-wheel mechanism behaves as a conventional drive mechanism wherein said sleeve is prevented from freewheeling inside said sprag bearing during deceleration and in turn preventing an attached wheel from free-wheeling during deceleration, and when said sleeve and said drive flange are not interlocked by said interlocking member said sleeve can free-wheel inside said sprag bearing during deceleration.

7. The free-wheel drive mechanism according to claim 6, wherein a snap-ring is used to hold said sprag bearing around said sleeve.
